(19) United States
(12) Patent Application Publication
(10) Pub. No.: US 2003/0178809 A1
(43) Pub. Date: Sep. 25, 2003

(54) Device for visually aligning a vehicle towing hitch and a trailer tongue

(76) Inventor: Elmer G. Anderson, Lombard, IL (US)

Correspondence Address: LAW OFFICE OF BRIAN R. RAYVE, P.O. Box 11586, Salt Lake City, UT, 84147-0586, US

(21) Appl. No.: 10/102,791

(22) Filed: Mar. 21, 2002

(51) Int. Cl. B60D 1/00

(52) U.S. Cl. 280/477

(57) ABSTRACT

A removable aligning device for visually aligning an upstanding hitch ball mounted centrally to the rear of a motorized towing vehicle with a mating inverted socket of a trailer to be towed to facilitate coupling thereof for towing. The device includes an alignment assembly having a base which is magnetically attachable to a rear panel of the towing vehicle. A telescoping alignment pole is connected to the magnetic base by a lockable hinge at one end and an opposite end which carries a ball visible through a rear window of the towing vehicle by the driver thereof.

The device further includes a target assembly having a forked plate base which is attachable to the tongue by placing respective legs thereof under the ball locking lever when in an unlocked position and moving the lever to a locked position wherein respective downwardly dependent legs of the lever cam-lock the base against the trailer tongue. A two-piece collapsible target pole is connected to the forked plate base by a lockable hinge at one end and an opposite end disposed thereabove. The respective hinges are adjusted such that when the magnetic base is attached centrally to the rear panel of the towing vehicle and the forked plate base is attached to the trailer tongue, vertical alignment of the ball and socket is visually indicated to the vehicle driver looking through the rear window when the ball of the alignment assembly contacts anywhere along the length of the target pole.

### BACKGROUND OF THE INVENTION

1. Field

The present invention relates to devices for visually aligning the ball of a towing hitch mounted to the rear of a motor vehicle with the inverted socket of a trailer to facilitate coupling thereof, and more specifically to such devices which are easily removable upon alignment being effected.

2. State of the Art

Boating enthusiasts, mobile home owners, and other users of trailers know the difficulty of visually aligning and coupling a trailer to a motorized towing vehicle. Lightweight trailers may be physically moved to where the towing vehicle is parked, or the towing vehicle may be backed into position with the ball in as close alignment with the socket as possible, the trailer tongue then moved into final alignment of the socket above the ball. The coupling procedure is typically hampered by poor rearward visibility by the vehicle driver of the ball relative to the socket of the trailer tongue. While the rear window and mirrors of the towing vehicle may be utilized, a second person positioned outside rearward of the towing vehicle is typically necessary to relay instructions to the vehicle driver. Many times such a second person is not available. Lightweight trailers typically have either an vertically disposed adjustable crank jack or a support pole having a plurality of pin-fixed heights to maintain the hitch at a particular height when the trailer is not attached to the towing vehicle. Regarding trailers having a support post, after the ball and socket are aligned the trailer tongue must be manually lifted, the support pin removed, the socket lowered onto the ball, and a ball locking lever engaged to retain the ball within the socket. The support post is then lifted to clear the ground and repinned in place. The safety chains are subsequently attached between the towing vehicle and the trailer tongue. Regarding trailers which have a jack, the procedure is the same except that no manual lifting of the trailer tongue is required.

For larger, heavier trailers such as those trailers with multiple sets of axles and tires used as mobile homes and to carry large boats, the above procedure is difficult if not impossible for one person to do. Therefore, the alignment of the upstanding ball to the socket must be nearly perfect prior to attaching them together. If there is nobody to help direct the driver, oftentimes multiple cycles of backing up, exiting the vehicle to check positioning, reentering the vehicle, and repositioning the vehicle are necessary. While most large trailers have a jack with a swivelable ground-contacting wheel to eliminate lifting of the trailer tongue, two people may still be required to pull the socket of the trailer tongue into proper alignment above the upstanding ball.

Various trailer alignment devices have been designed in an attempt to improve the alignment process. For example, in U.S. Pat. No. 4,285,138 issued to Berry is disclosed a visual alignment device for use with towing vehicles such as automobiles and trucks to tow trailers. The alignment device includes a pair of magnetic bases each carrying an outwardly extending, one-piece.

The wands are connected to the respective bases using an annularly toothed hinge to permit finite angular adjustments. Each wand includes a slidable elastic grommet that is positionable therealong to retain a signal flag on an upper side of the wand and a downwardly dependent plumb line. The bases are placed one on a rear surface of the towing vehicle and one on the tongue of the trailer to be towed. The angle of the wands and the position of the grommets are adjusted prior to backing the towing vehicle such that when the vehicle driver sees the alignment flags touch, the correct alignment has been achieved and hook-up can be effectuated.

The aligning device has deficiencies including that the wands and the alignment flags are rather small and presumably difficult to see from inside the towing vehicle. The plumb lines are rather unwieldy and cannot be used on towing vehicles wherein there is a vertical obstruction between the wand and the hitch ball, such as a rearwardly protruding bumper. Finally, the angle of the wands and the position of the grommets must be adjusted each time used since the placement of the bases will vary upon each subsequent use.

In U.S. Pat. No. 3,818,599 issued to Tague is disclosed a visual guide device similar to the alignment device of Berry, except that telescoping wands tipped with respective guide balls and infinitely adjustable hinges are used. The bases are placed one on a horizontal surface of the towing hitch mounted to the towing vehicle and one on the tongue of the trailer to be towed. The length and angle of the wands are adjusted such that the respective guide balls are vertically aligned with the tow ball of the towing hitch and the socket of the trailer tongue prior to backing the towing vehicle. When the vehicle driver sees the guide balls touch, the correct alignment has been achieved and hook-up can be effectuated. The visual guide device has deficiencies including that the wands and the guide balls are rather small and presumably difficult to see from inside the towing vehicle. One of the bases must be placed on a horizontal surface of the towing hitch such that is there is no horizontal surface or if the towing vehicle has a rearwardly protruding bumper that prevents the wand from achieving the required upward angle, the visual alignment device cannot be used. The length and angle of the wands must be adjusted each time used since the placement of the bases will vary upon each subsequent use. Finally, the wands appear to have a rather limited range of angular motion.

In U.S. Pat. No. 5,290,056 issued to Fath, IV is disclosed a trailer hitch guide that includes a pair of permanently attaching bases, one affixed to the towing hitch and one to the tongue of the trailer to be towed. An adjustable height wand extends vertically from each base, one terminating at a guide ball and the other at a forwardly extending hood at a height equal to that of the guide ball. The spacial relation between the guide ball and the hood emulates the spacial relation between the hitch ball and the socket of the tongue. The height of the wands and the forward position of the hood are adjusted prior to backing the towing vehicle such that when the vehicle driver sees the correct spacial relation between the guide ball and the hood, the correct alignment has been achieved and hook-up can be effectuated. The aligning device has several deficiencies including that the trailer hitch guide permanently attaches to the trailer hitch and trailer tongue, being removable only using hand tools. This may interfere with the hitching and unhitching activities, being not easily removable. One of the bases must be affixed to a horizontal surface of the towing hitch. If there is no horizontal surface or if the towing vehicle has a rearwardly protruding bumper that prevents such vertical mounting of the wand, the trailer hitch guide cannot be used. Finally, the angle of the hood is likely to be inadvertently changed by accidental bumping due to the extended length from the respective wand.

There is a need for an aligning device which is easily attachable and removable, does not need to be adjusted at each time of use, that is essentially self-positioning, mountable in a variety of positions to suit the particular towing vehicle, has a wide angular range of motion, and which is easily visible by the vehicle driver.

### SUMMARY OF THE INVENTION

The present invention is a removable aligning device for visually vertically aligning an upstanding ball of a towing device mounted to the rear end of a motorized towing vehicle with an inverted socket of the tongue of a towable trailer to facilitate coupling thereof. The towing vehicle is of the type having a transparent rear window and a central rear panel made of a ferrous metal. The tongue is of the type having a ball lock lever pivotally mounted thereto on a mounting bracket and which includes a pair of dependent lower legs. The lever retains the ball within the socket when the lever is in a clamped position and releases the ball when in a released position. The trailer is of the type having a vertical jack mounted to the tongue for maintaining the tongue at a desired vertical position when unhitched from the towing vehicle. The aligning device comprises an alignment assembly and a target assembly. The alignment assembly includes a base which is removably attachable to the rear panel of the towing vehicle, an alignment pole having a first end affixed to the base through a lockable hinge and a distal end, and a visual attraction device affixed to the distal end. The target assembly includes a base which is removably attachable to the tongue, a target pole having a first end operatively affixed to the base, and a distal end. When the base is attached centrally to the rear panel, the base is attached to the tongue, and the hinge is adjusted for the towing vehicle and trailer, vertical alignment of the ball and socket is visually indicated to the vehicle driver looking through the rear window when the visual attraction device contacts the target pole.

### THE DRAWINGS

The best mode presently contemplated for carrying out the invention is illustrated in the accompanying drawings, in which:

FIG. 1 is a fragmentary perspective view of an exemplary removable aligning device in accordance with the present invention as connected to the rear of a towing vehicle comprising a sport utility vehicle and to the tongue of a boat trailer to be towed;

FIG. 2, a side elevational view of an alignment assembly of the aligning device;

FIG. 3, an exploded perspective view of the alignment assembly;

FIG. 4, a perspective view of a target assembly of the aligning device;

FIG. 5, an exploded perspective view of the target assembly;

FIG. 6, a fragmentary side elevational view of the aligning device as the sport utility vehicle with the alignment assembly is backed toward the tongue of the boat trailer with the target assembly;

FIG. 7, a fragmentary side elevational view corresponding to FIG. 6, but with the sport utility vehicle backed further such that an end ball of the pointer assembly touches an upper tube of the target assembly indicating correct vertical alignment of the hitch ball and the trailer socket;

FIG. 8, a fragmentary perspective view of the aligning device as connected to the rear of a towing vehicle comprising an automobile and to the tongue of the boat trailer; and

FIG. 9, a fragmentary perspective view of the aligning device as connected to the rear of a towing vehicle comprising a pick-up truck and to the tongue of the boat trailer.

### DETAILED DESCRIPTION OF THE ILLUSTRATED EMBODIMENTS

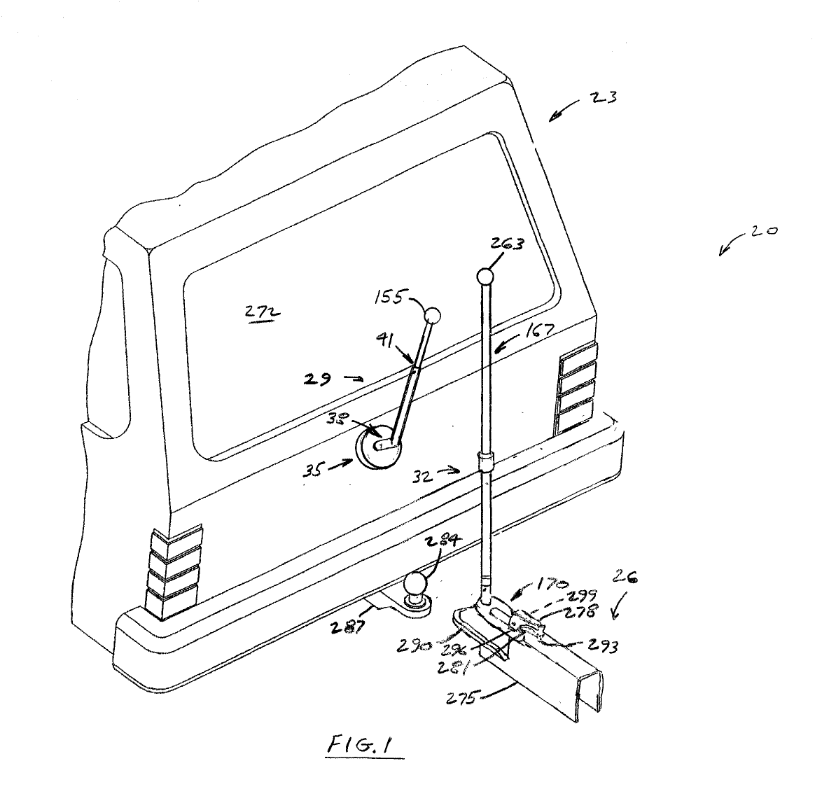

Referring to FIG. 1, therein is shown an exemplary removable aligning device in accordance with the present invention, designated generally at 20, attached to a motorized towing vehicle comprising a sport utility vehicle 23 and a towable vehicle comprising a boat trailer 26. The alignment device 20 comprises an alignment assembly 29 and a target assembly 32.

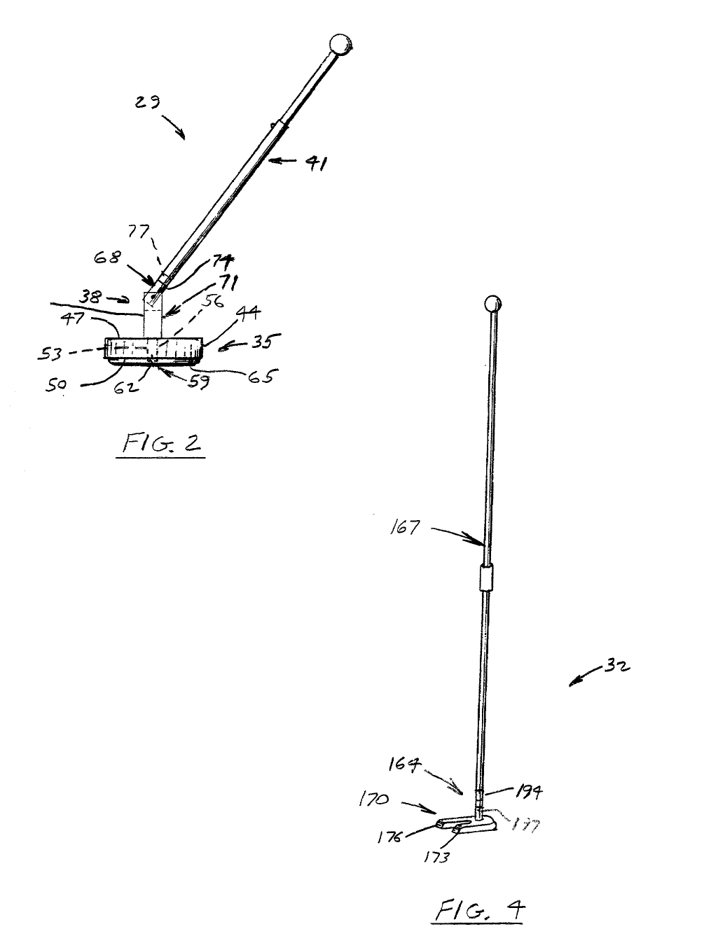

As best shown in FIGS. 2 and 3, the alignment assembly 29 includes a magnetic base 35, a hinge 38, and a telescoping alignment pole 41. The base 35 includes a disc shaped magnet 44 having respective circular upper and lower surfaces 47 and 50, and a central hole 53 therethrough to accept the threaded shaft 56 of a hex-head bolt 59. The central hole 53 is counterbored (not shown) at the rear surface 50 to a diameter and a depth sufficient to render a hexagonal head 62 of the hex-head bolt 59 flush with the rear surface 50 and to permit engaging of the head 62 by a socket wrench during assembly of the alignment assembly 29. A non-scratching pad 65 made of felt, cloth, plastic or other such material which is non-marring to painted surfaces is adhesively affixed to the rear surface 50 after the bolt 59 is tightened.

The hinge 38 includes an upper hinge 68 and a lower hinge 71, both preferably made from cylindrical metal stock such as brass, aluminum, or steel. The upper hinge 68 includes a cylindrical central portion 74, a cylindrical upper portion 77 of a smaller diameter than the central portion 74, and a downwardly extending tab 80 having a rounded end 83. The tab 80 has a pivot hole 86 which extends transversely therethrough. The lower hinge 71 includes an upper portion 89 and a lower portion 92. The upper portion 89 has an arcuate end 95 and a transverse end slot 98 of a width so as to closely accept the tab 80. A pivot hole 101 extends transversely through the upper portion 89. The upper portion 89 is pivotally and lockably connected to the lower portion 92 using a bolt 104 which extends through the pivot holes 86 and 101, along with a flat washer 107, a lock washer 110, and a nut 113. The lower portion 92 of the lower hinge 71 has a longitudinal threaded hole (not shown) into which the bolt 59 threads to secure the base 35 to the hinge 38.

The alignment pole 41 includes a solid upper pole 116 which closely fits into a tubular lower pole 119 in a telescoping manner. The upper pole 116 includes an upper end 122 having a threaded hole 125 which extends longitudinally thereinto and a lower end 128. A shallow longitudinal slot 131 extends from the upper end 122 for most of the length of the upper pole 116. A plurality of shallow detentes 134 are linearly disposed inside of the slot 131.

The lower pole 119 includes an upper end 137 and a lower end 140.

The upper end 137 has a threaded hole 143 which extends transversely thereinto. A spring pin 146 includes an externally threaded housing 149 and an outwardly biased, rounded end plunger 152 which threads into the threaded hole 140. The end plunger 152 engages the respective detentes 134 to provide a plurality of lengths for the telescoping pole 41. The end plunger 152 slides along the longitudinal slot 131 to prevent rotation and removal of the upper pole 116 from the lower pole 119. The upper portion 77 of the upper hinge 68 closely fits within the lower end 140 of the lower pole 119, being affixed together such as by pressfitting, adhesives, or pinning. A ball 155 having a threaded shaft 158 threads into the threaded hole 125 to provide better visibility for the driver of the sport utility vehicle 23.

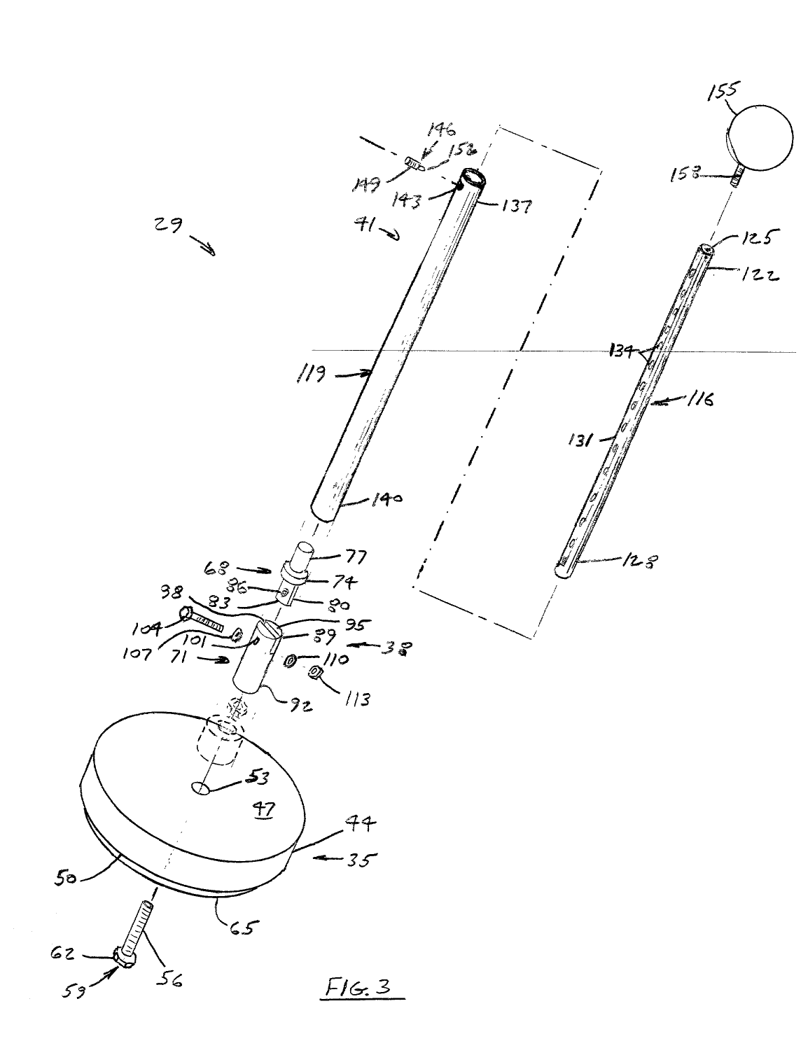

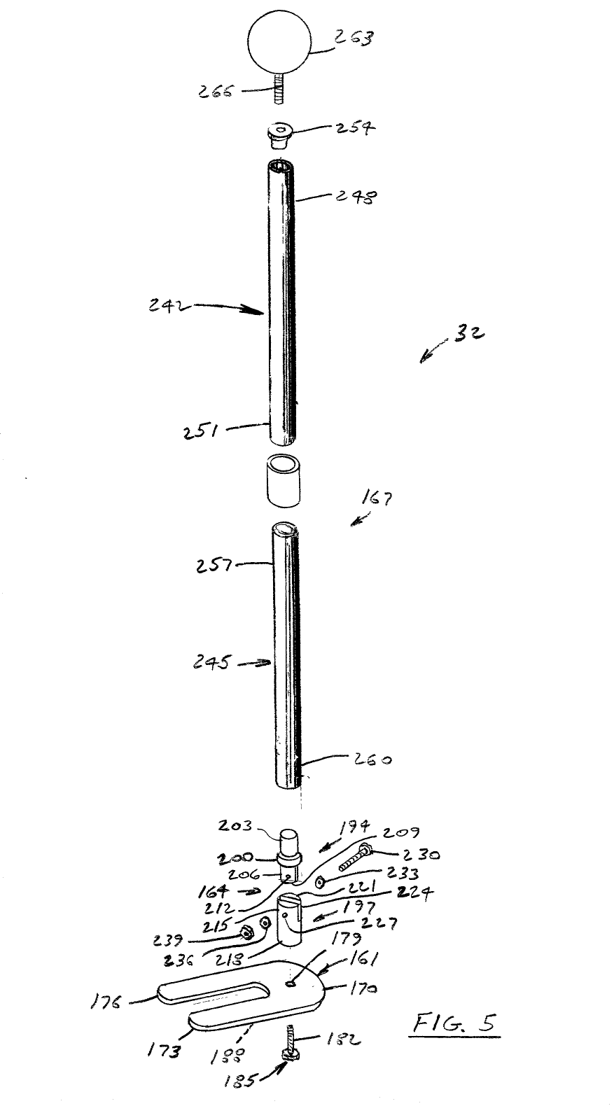

As best shown in FIGS. 4 and 5, the target assembly 32 includes a forked plate base 161, a hinge 164, and a collapsible two-section target pole 167. The base 161 includes a base portion 170 and a pair of dependent legs 173 and 176. The base 161 includes a pole mounting hole 179 therethrough to accept the threaded shaft 182 of a flathead screw 185. The pole mounting hole 179 is countersunk (not shown) at a bottom surface 188 thereof to a diameter and a depth sufficient to render a flat head 191 of the flathead screw 185 flush with the bottom surface 188.

The hinge 164 includes an upper hinge 194 and a lower hinge 197, both preferably made from cylindrical metal stock such as brass, aluminum, or steel. The upper hinge 194 includes a cylindrical central portion 200, a cylindrical upper portion 203 of a smaller diameter than the central portion 200, and a downwardly extending tab 206 having a rounded end 209. The tab 206 has a pivot hole 212 which extends transversely therethrough. The lower hinge 197 includes an upper portion 215 and a lower portion 218. The upper portion 215 has an arcuate end 221 and a transverse end slot 224 of a width so as to closely accept the tab 206. A pivot hole 227 extends transversely through the upper portion 215. The upper portion 215 is pivotally and lockably connected to the lower portion 218 using a bolt 230 which extends through the pivot holes 212 and 227, along with a flat washer 233, a lock washer 236, and a nut 239. The lower portion 218 of the lower hinge 197 has a longitudinal threaded hole (not shown) into which the flathead screw 185 threads to secure the base 161 to the hinge 164.

The target pole 167 includes a tubular upper pole 242 and a tubular lower pole 245. The upper pole 242 includes an upper end 248 and a lower end 251. An internally threaded insert 254 is affixed within upper end 248 such as by pressfitting or pinning. The lower pole 245 includes an upper end 257 and a lower end 260. A connector tube 263 closely fits around and is affixed to upper end 257 of lower pole 245 such as by using adhesives or pinning. The lower end 251 of the upper pole 242 closely removably frictionally fits within connector tube 263 in abutting relationship with the upper end 257 of lower pole 245. The upper portion 203 of the upper hinge 194 closely fits within the lower end 260 of the lower pole 245, being affixed together such as by pressfitting, adhesives, or pinning. A ball 263 having a threaded shaft 266 threads into the insert 254 to provide better visibility for the driver of the sport utility vehicle 23.

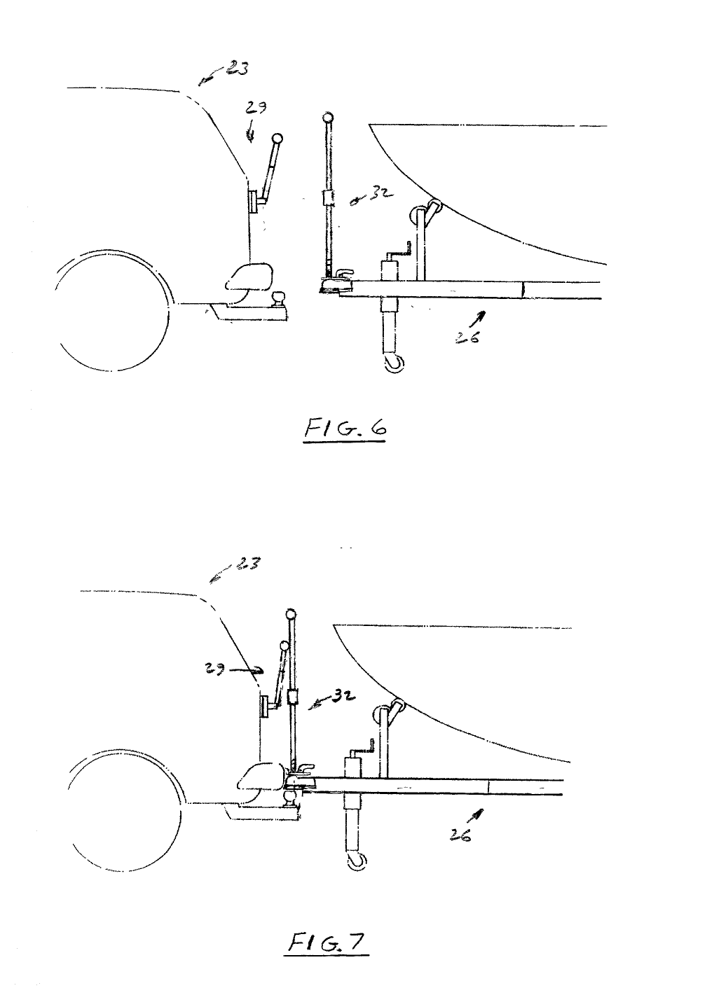

Shown in FIGS. 1, 6, and 7 is how the removable aligning device 20 removably mounts to the sport utility vehicle 23 and the boat trailer 26. The magnetic base 35 of the alignment assembly 29 is magnetically secured centrally to a ferrous steel rear panel 269 of the vehicle 23 with the telescoping alignment pole 41 angled upwardly as shown. The angle of the alignment pole 41 may be adjusted by loosening bolt 104 and nut 113, repositioning the angle of telescoping alignment pole 41, then retightening such that the hinge 38 is frictionally locked in the desired position. The length of the alignment pole 41 then is adjusted to the position shown by grasping the upper pole 116 in one hand, lower pole 119 in the other hand, and pulling or pushing upper pole 116 so as to depress plunger 152 of spring pin 146 secured to lower pole 119. The ball 155 is positioned so as to be visible to the vehicle driver through the rear window 272 of sport utility vehicle 23. Next, the target assembly 32 is mounted to a trailer tongue 275 of the boat trailer 26 by unlocking a conventional ball lock lever 278 which is pivotally mounted to the trailer tongue 275 at a mounting bracket 281. The ball lock lever 278 clamps a hitch ball 284 of a trailer hitch 287 mounted to the sport utility vehicle 23, within a ball receiving socket 290 of trailer tongue 275 through an internal connecting mechanism (not shown). A locking mechanism (not shown) retains ball lock lever 278 in the horizontally dispose locked position shown to retain the hitch ball 284 within the ball receiving socket 290 until a release lever 293 is actuated to release the ball lock lever 278 to a vertically disposed unlocked position (not shown). The legs 173 and 176 of forked plate base 161 are spaced apart at such a distance as to closely fit around the mounting bracket 281 and under respective lower legs 296 and 299 of the ball lock lever 278 when in the unlocked position. When the ball lock lever 278 is subsequently moved to the locked position, lower legs 296 and 299 act as respective cams to firmly retain the forked plate base 161 along with the lower pole 245. The angle of the two-section pole 167 may be adjusted by loosening bolt 230 and nut 239, repositioning the angle of two-section pole 167, then retightening such that the hinge 164 is frictionally locked in the desired position. The lower end 251 of upper pole 242 frictionally fits into the connector tube 263 so as to permit ball 263 to be visible to the vehicle driver through the rear window 272 of sport utility vehicle 23. Once the alignment assembly 29 and the target assembly 32 are initially adjusted for the particular towing vehicle such as the sport utility vehicle 23, no further adjustments are necessary for subsequent use. The alignment assembly is merely placed onto the sport utility vehicle 23 visually aligning the ball 263 vertically with the towing ball 284. The angle and length of the alignment pole 41 are already set, or the proper length can be marked in ink thereon and the alignment pole 41 collapsed for storage. The relatively short length of the alignment pole 41 makes visual vertical alignment of the ball 263 with the towing ball 284 easy. The target assembly 32 is then clamped to the trailer tongue 275 with the target pole 167 already adjusted for the particular trailer tongue 275.

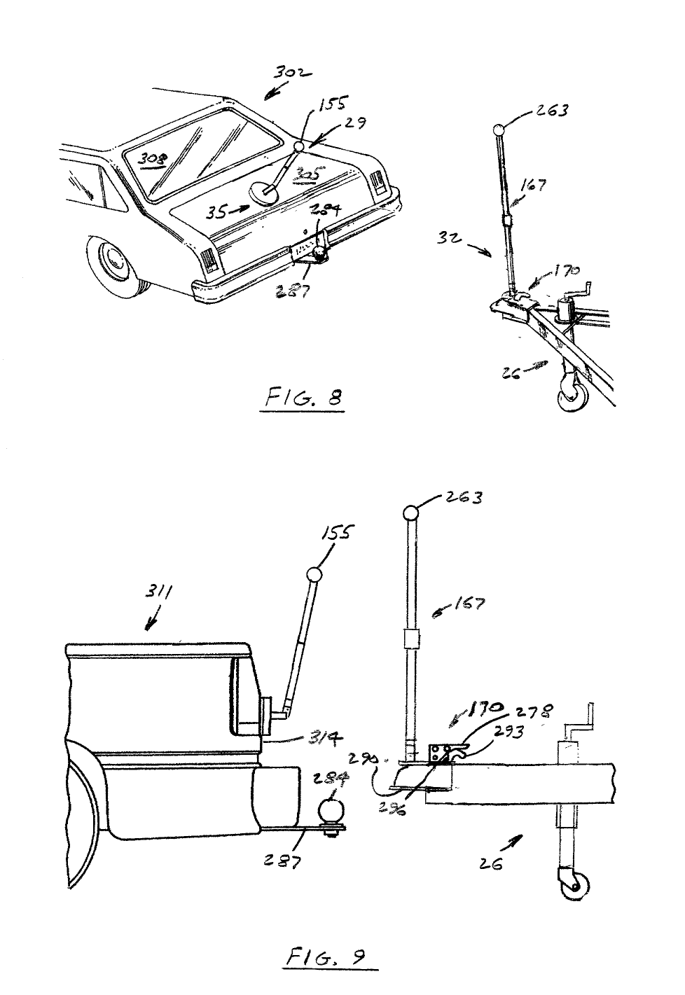

Shown in FIG. 8 is how the removable aligning device 20 removably mounts to an automobile 302 and the boat trailer 26. The procedure is similar, wherein the magnetic base 35 of the alignment assembly 29 is magnetically secured to a rear panel 305 of the automobile 302 with the telescoping alignment pole 41 angled upwardly as shown. The angle and length of the telescoping alignment pole 41 are adjusted as explained above such that the ball 155 is positioned so as to be visible to the vehicle driver through a rear window 308 of the automobile 302. The target assembly 32 is mounted to a trailer tongue 275 of the boat trailer 26 as explained above. The angle of the two-section target pole 167 may be adjusted as explained above. It is desirable that the target pole be vertically disposed directly above the socket 290 so that the ball 155 may contact anywhere along the length of the target pole 167 and have proper alignment. If the target pole 167 is at an angle, the point at which the ball 155 contacts the target pole 167 may need to be adjusted so that contact point is substantially vertically aligned with the socket 290. The lower end 251 of upper pole 242 frictionally fits into the connector tube 263 so as to permit ball 263 to be visible to the vehicle driver through the rear window 308 of the automobile 302.

Shown in FIG. 9 is how the removable aligning device 20 removably mounts to a pickup truck 311 and the boat trailer 26. The procedure is likewise similar, wherein the magnetic base 35 of the alignment assembly 29 is magnetically secured to a rear panel 314 of the pickup truck 311 with the telescoping alignment pole 41 angled upwardly as shown. The angle and length of the telescoping alignment pole 41 are adjusted as explained above such that the ball 155 is positioned so as to be visible to the vehicle driver through a rear window 317 of the pickup truck 311. The target assembly 32 is mounted to a trailer tongue 275 of the boat trailer 26 as explained above. The angle of the two-section target pole 167 may be adjusted as explained above. The lower end 251 of upper pole 242 frictionally fits into the connector tube 263 so as to permit ball 263 to be visible to the vehicle driver through the rear window 317 of the pickup truck 311.

Many variations of the removable aligning device are possible while staying within the same inventive concept. For example, many different types of hinges may be used, including those frictional hinges that do not require loosening of a bolt to change position. Furthermore, the target pole may be collapsible in other manners or even telescoping. Likewise, the particular shape of the magnetic base may be changed.

Whereas this invention is here illustrated and described with reference to embodiments thereof presently contemplated as the best mode of carrying out such invention in actual practice, it is to be understood that various changes may be made in adapting the invention to different embodiments without departing from the broader inventive concepts disclosed herein and comprehended by the claims that follow.

I claim:

1. A removable aligning device for visually vertically aligning an upstanding ball of a towing device mounted to the rear end of a motorized towing vehicle with an inverted socket of the tongue of a towable trailer to facilitate coupling thereof, the towing vehicle having a transparent rear window and a central rear panel made of a ferrous metal, the tongue having a ball lock lever pivotally mounted thereto on a mounting bracket and which lever includes a pair of dependent lower legs, the lever which retains the ball within the socket when the lever is in a clamped position and releases the ball when in a released position, the trailer having a vertical jack mounted to the tongue for maintaining the tongue at a desired vertical position when unhitched from the towing vehicle, the aligning device comprising:
an alignment assembly having a base which is removably attachable to the rear panel of the towing vehicle, an alignment pole having a first end affixed to said base through a lockable hinge and a distal end, and a visual attraction device affixed to said distal end;
a target assembly having a base which is removably attachable to the tongue, a target pole having a first end operatively affixed to said base, and a distal end; and
wherein when said base of said alignment assembly is attached centrally to the rear panel, said base of said target assembly is attached to the tongue, and said hinge is adjusted for the towing vehicle and trailer, vertical alignment of the ball and socket is visually indicated to the vehicle driver looking through the rear window when said attraction device contacts said target pole.

2. An aligning device according to claim 1, wherein the base of the target assembly comprises a forked plate having a base portion and a pair of dependent legs of such a thickness and spaced apart at such a distance so as to closely fit around the mounting bracket under the lower legs of the lever when in the unlocked position and being clamped thereunder in the locked position to retain said target assembly to the tongue.

3. An aligning device according to claim 2, wherein at least one of the alignment pole and the target pole are of an adjustable length.

4. An aligning device according to claim 3, wherein the alignment pole is of the adjustable length comprising at least a pair of poles which fit together in a telescoping fashion.

5. An aligning device according to claim 3, wherein the target pole is of the adjustable comprising a collapsible two-section pole.

6. An aligning device according to claim 1, wherein the base of the alignment assembly comprises a magnetic base having a magnet with respective upper and lower surfaces, and a non-scratching pad, the hinge being connected at said upper surface of said magnet and said pad being affixed to said rear surface of said magnet.

7. An aligning device according to claim 6, wherein the base of the target assembly comprises a forked plate having a base portion and a pair of dependent legs of such a thickness and spaced apart at such a distance so as to closely fit around the mounting bracket under the lower legs of the lever when in the unlocked position and being clamped thereunder in the locked position to retain said target assembly to the tongue.

8. An aligning device according to claim 7, wherein at least one of the alignment pole and the target pole are of an adjustable length.

9. An aligning device according to claim 8, wherein the alignment pole is of the adjustable length comprising at least a pair of poles which fit together in a telescoping fashion.

10. An aligning device according to claim 8, wherein the target pole is of the adjustable length comprising a collapsible two-section pole.

11. An aligning device according to claim 1, wherein the alignment pole is of the adjustable length, comprising an upper pole and a lower pole that fit together in a telescoping manner, one of said upper and lower poles having a plurality of detentes linearly disposed therealong, another of said upper and lower poles having a spring pin with a spring-biased plunger which is individually engagable with said detentes so as to provide a plurality of predetermined lengths for said alignment pole.

12. An aligning device according to claim 11, wherein the upper pole fits within the lower pole in the telescoping manner, said upper pole having the plurality of detentes and said lower pole having the spring pin.

13. An aligning device according to claim 11, wherein the one of the upper and lower poles having the plurality of detentes includes a longitudinal slot inside of which said plurality of detentes are linearly disposed, the end plunger of the spring pin being slidable along said longitudinal slot to prevent relative rotation of said the upper and lower poles, said longitudinal slot having an end wall which prevents removal of said upper pole from said lower pole during use.

14. An aligning device according to claim 13, wherein the upper pole fits within the lower pole in the telescoping manner, said upper pole having the plurality of detentes and said lower pole having the spring pin.

15. An aligning device according to claim 1, wherein the first end of the target pole is operatively connected to the base through a second lockable hinge such that said target pole is pivotable longitudinally of the legs of the base.

16. An aligning device according to claim 15, wherein the target pole is of the adjustable length comprising a collapsible two-section pole.

17. A removable aligning device for visually vertically aligning an upstanding ball of a towing device mounted to the rear end of a motorized towing vehicle with an inverted socket of the tongue of a towable trailer to facilitate coupling thereof, the towing vehicle having a transparent rear window and a central rear panel made of a ferrous metal, the tongue having a ball lock lever pivotally mounted thereto on a mounting bracket and which lever includes a pair of dependent lower legs, the lever which retains the ball within the socket when the lever is in a clamped position and releases the ball when in a released position, the trailer having a vertical jack mounted to the tongue for maintaining the tongue at a desired vertical position when unhitched from the towing vehicle, the aligning device comprising:
an alignment assembly having a base which is removably attachable to the rear panel of the towing vehicle, an alignment pole having a first end affixed to said base through a lockable hinge and a distal end, and a visual attraction device affixed to said distal end, said base comprising a magnetic base having a magnet with respective upper and lower surfaces and a non-scratching pad, said hinge being connected at said upper surface of said magnet and said pad being affixed to said rear surface of said magnet, said alignment pole being of the adjustable length comprising an upper pole and a lower pole that fit together in a telescoping manner, one of said upper and lower poles having a plurality of detentes linearly disposed therealong, another of said upper and lower poles having a spring pin with a spring-biased plunger which is individually engagable with said plurality of detentes so as to provide a plurality of predetermined lengths for said alignment pole;
a target assembly having a base which is removably attachable to the tongue, a target pole having a first end operatively affixed to said base, and a distal end, said base of said target assembly comprising a forked plate having a base portion and a pair of dependent legs of such a thickness and spaced apart at such a distance so as to closely fit around the mounting bracket under the lower legs of the lever when in the unlocked position and being clamped thereunder in the locked position to retain said target assembly to the tongue; and
wherein when said base of said alignment assembly is attached centrally to the rear panel, said base of said target assembly is attached to the tongue, and said hinge is adjusted for the towing vehicle and trailer, vertical alignment of the ball and socket is visually indicated to the vehicle driver looking through the rear window when said attraction device contacts said target pole.

18. An aligning device according to claim 17, wherein the upper pole fits within the lower pole in the telescoping manner, said upper pole having the plurality of detentes and said lower pole having the spring pin.

19. An aligning device according to claim 17, wherein the first end of the target pole is operatively connected to the base through a second lockable hinge such that said target pole is pivotable longitudinally of the legs of the base.

20. An aligning device according to claim 19, wherein the one of the upper and lower poles having the plurality of detentes includes a longitudinal slot inside of which said plurality of detentes are linearly disposed, the end plunger of the spring pin being slidable along said longitudinal slot to prevent relative rotation of said the upper and lower poles, said longitudinal slot having an end wall which prevents removal of said upper pole from said lower pole during use.
